(19) United States
(12) Patent Application Publication
(10) Pub. No.: US 2006/0283480 A1
(43) Pub. Date: Dec. 21, 2006

(54) Dental tooth pick

(76) Inventor: Jennifer Salzer, New York, NY (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/156,780

(22) Filed: Jun. 20, 2005

(51) Int. Cl. A61C 15/00

(52) U.S. Cl. 132/329

(57) ABSTRACT

A dental tooth pick for enabling a user to remove an undesired particle or particles from or between one or more of the user's teeth. The tooth pick may have a handle portion which enables the user to hold the tooth pick during use and an end portion having an outer cross-sectional shape which has a dimension having a value of approximately 4 mm or larger. The end portion may have an opening for enabling the removed undesired particle or particles to be collected therein. At least a part of the end portion may be fabricated from a transparent-type material which includes a number of markings on a surface thereof positioned at predetermined locations to enable an indication to be provided to the user of the amount of removed particles. Additionally, at least a part of the end portion may be coated with an anti-bacterial coating.

### BACKGROUND OF THE INVENTION

The present invention relates to a dental tooth pick and, in particular, to such tooth pick which facilitates the removal of a relatively large amount of undesired particles from or between a user's teeth.

A tooth pick may be used by a person to remove an undesired particle from or between his or her teeth. Typically, each time the person removes a single undesired particle from his or her teeth, the person may wipe the removed particle from the end of the tooth pick. As such, if a person wishes to remove multiple particles from his or her teeth, the person may perform the removal and wiping operation multiple times. As is to be appreciated, repeating such operations may be inconvenient, awkward, embarrassing and/or cumbersome.

### SUMMARY OF THE INVENTION

In accordance with an embodiment of the present invention, a dental tooth pick is provided which is adapted to enable a user to remove an undesired particle or particles from or between one or more of the user's teeth. Such tooth pick may have a handle portion for enabling the user to hold the tooth pick during use and an end portion having an outer cross-sectional shape which has a dimension having a value of approximately 4 mm or larger. The end portion may have an opening for enabling the removed undesired particle or particles to be collected therein. The cross-sectional shape may be a circle, triangle, rectangle, square, or other geometric shape. If the cross-sectional shape is a circle, then the dimension may be the diameter of the circle. And, if the cross-sectional shape is a square, rectangle, or triangle, then the dimension may represent the length of one side thereof.

In accordance with another embodiment of the present invention, a dental tooth pick is provided which is adapted to enable a user to remove an undesired particle or particles from or between one or more of the user's teeth. Such tooth pick may have a substantially cylindrical shape with an outer diameter of approximately 4 mm or larger and an opening provided at at least one end of the tooth pick to enable the removed undesired particle or particles to be collected therein.

In accordance with yet another embodiment of the present invention, a dental tooth pick assembly is provided which is adapted to enable a user to remove an undesired particle or particles from or between one or more of the user's teeth. Such assembly may have a handle portion for enabling the user to hold the tooth pick during use and a removable end portion having an outer cross-sectional shape which has a dimension having a value of approximately 4 mm or larger. The end portion may have an opening for enabling the removed undesired particle or particles to be collected therein.

At least a part of the tooth pick (such as a part or all of the end portion) may be fabricated from a transparent-type material. Additionally, a number of markings may be provided on a surface of the transparent-type material which are positioned at predetermined locations so as to enable an indication to be provided to the user of the amount of removed particles. Further, at least a part of the tooth pick may be coated with an anti-bacterial coating. Furthermore, an end of the tooth pick may be tapered at a predetermined angle, which may have a value in the range of 30 to 60 degrees (such as approximately 45 degrees) relative to a longitudinal axis of the tooth pick.

The present invention will now be described in more complete detail with reference being made to the drawing figures, which are identified below in which corresponding components are identified by the same reference numerals.

### BRIEF DESCRIPTION OF THE DRAWINGS

FIGS. 1A and B are diagrams of a tooth pick in accordance with an embodiment of the present invention;

FIGS. 2A and B are diagrams of a tooth pick in accordance with another embodiment of the present invention;

FIGS. 3A and B are diagrams of a modification of the tooth pick shown in FIGS. 2A and B; and

FIG. 4A-C are diagrams of cross-sectional shapes which may be utilized in the present tooth pick.

### DETAILED DESCRIPTION OF THE PREFERRED EMBODIMENTS

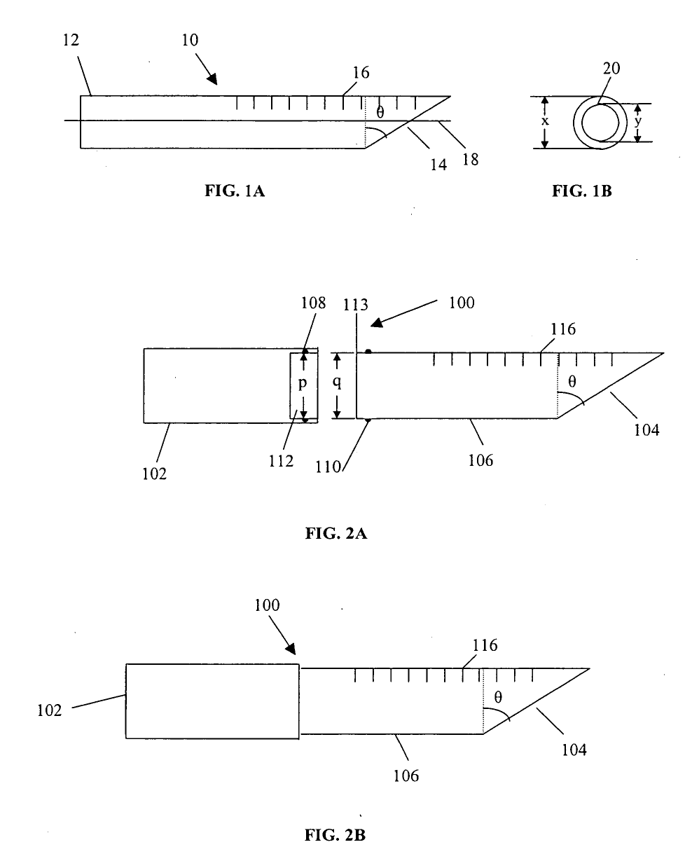

FIGS. 1A and 1B are diagrams of a tooth pick 10 in accordance with an embodiment of the present invention.

More specifically, the tooth pick 10 may have a substantially circular cross-section shape with an outer diameter X of approximately 4 mm or larger and an inner diameter Y. The value of the inner diameter Y is less than the value of the outer diameter X and may have a value of approximately 3 mm or less.

The tooth pick 10 may include a handle portion 12 and an end portion 14. The end portion may have a tapered surface 14, which may be arranged at an angle θ relative to a line which is perpendicular to a longitudinal axis 18. The angle θ may have a value which is greater than zero and less than 90 degrees and, in particular, may lie in the range between 30 and 60 degrees. As an example, the angle θ may have a value of 45 degrees.

The tooth pick 10 may have an opening 20 at the end portion 14. Such opening 20 may have a circular cross-section as illustrated in FIG. 1B. The opening 20 may extend from the end portion 14 to the opposite end of the tooth pick 10, or alternatively, the opening 20 may stop at an intermediate location.

Further, the tooth pick 10 may be fabricated from a paper or a plastic-type material. Alternatively, the tooth pick 10 may be fabricated from a transparent-type material. Additionally, the tooth pick 10 may include a number of markings 16 which may be located at predetermined intervals along the tooth pick.

Furthermore, a part or the entire tooth pick 10 may be coated with an anti-bacterial coating. As an example, a part of the end portion 14 may be provided with such anti-bacterial coating.

In use, a user may hold the tooth pick 10 at the handle portion 12 and place the end portion 14 in his/her mouth. The user would then remove any undesired particle or particles from or between his/her teeth. As is to be appreciated, if the tooth pick 10 is fabricated from a transparent-type material, the markings 16 would provide an indication to the user as to the amount of undesired particles which the user has removed from or between his/her teeth.

By providing the tooth pick 10 with a sufficiently large diameter (such as 4 mm), such tooth pick may facilitate the removal of undesired particles from or between the user's teeth. Additionally, by providing the tooth pick 10 with a sufficiently large inner diameter, but not too large as to impair the desired strength or flexibility, the tooth pick 10 may enable the user to collect a relatively large amount of undesired particles.

FIGS. 2A and 2B illustrate a tooth pick 100 in accordance with another embodiment of the present invention.

The tooth pick 100 is similar to the tooth pick 10, except that a handle portion 102 and an end portion 106 are separate parts which may be coupled together to form the tooth pick 100. As an example of a coupling mechanism, the handle portion 102 may have a cavity 112 adapted to receive an end 113 of the end portion 106. Diameter p of the handle portion 102 and diameter q of the end portion 106 may be selected top ensure a tight or snug fit. Additionally, a ridge 110 may be provided on the outer surface of the end portion 106 and a corresponding indentation 108 may be provided on the handle portion 102 to secure the handle portion to the end portion when coupled together as shown in FIG. 2B.

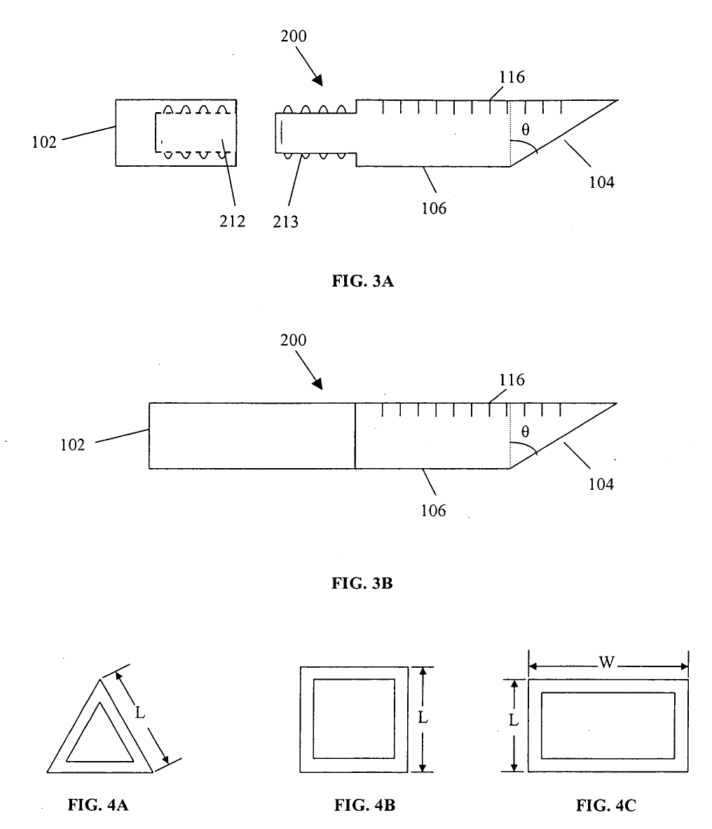

An alternative coupling mechanism is provided in a tooth pick 200 illustrated in FIGS. 3A and 3B. More specifically, the tooth pick 200 may include end portion 106 having a threaded portion 213 and handle portion 102 having a corresponding internal threaded portion 212. As is to be appreciated, the end portion 106 may be coupled to the handle portion 102 by threading the threaded portion 213 into the threaded portion 212.

In the tooth picks 100 and 200, a user may reuse the handle portions with new or replacement end portions.

Although the above tooth picks have been described as having a circular cross section, the present invention is not so limited. For example, the present tooth pick may have other cross-sectional shapes such as a triangular cross-section as shown in FIG. 4A, a square shaped cross-section as shown in FIG. 4B, or a rectangular cross-section as shown in FIG. 4C, or any other geometric shaped cross section. In such situations, the value of the length L may be 4 mm or larger.

Although preferred embodiments of the present invention and modifications thereof have been described in detail herein, it is to be understood that this invention is not limited to those precise embodiments and modifications, and that other modifications and variations may be effected by one skilled in the art without departing from the spirit and scope of the invention as defined by the appended claims.

1. A dental tooth pick for enabling a user to remove an undesired particle or particles from or between one or more of the user's teeth, said tooth pick having a handle portion which enables the user to hold said tooth pick during use and an end portion having an outer cross-sectional shape which has a dimension having a value of approximately 4 mm or larger, said end portion having an opening for enabling the removed undesired particle or particles to be collected therein.

2. The tooth pick of claim 1, wherein at least a part of said end portion is fabricated from a transparent-type material which includes a number of markings on a surface thereof which are positioned at predetermined locations so as to enable an indication to be provided to the user of the amount of removed particles.

3. The tooth pick of claim 1, wherein at least a part of said end portion is coated with an anti-bacterial coating.

4. The tooth pick of claim 1, wherein the end portion is tapered at an angle with regard to a line perpendicular to a longitudinal axis of the tooth pick which has a value greater than 0 degrees and less than 90 degrees.

5. The tooth pick according to claim 1, wherein the opening extends from the end portion to an end opposite said end portion.

6. The tooth pick according to claim 1, wherein the cross-sectional shape is a triangle and wherein said dimension is a length of one side of said triangle.

7. The tooth pick according to claim 1, wherein the cross-sectional shape is a circle and wherein said dimension is a diameter of said circle.

8. The tooth pick according to claim 1, wherein the cross-sectional shape is a rectangle and wherein said dimension is a length of one side of said rectangle.

9. The tooth pick according to claim 1, wherein the cross-sectional shape is a square and wherein said dimension is a length of a side of said square.

10. A dental tooth pick for enabling a user to remove an undesired particle or particles from or between one or more of the user's teeth, said tooth pick having a substantially cylindrical shape with an outer diameter of approximately 4mm or larger and an opening provided at at least one end of said tooth pick for enabling the removed undesired particle or particles to be collected therein.

11. The tooth pick according to claim 10, wherein said tooth pick is fabricated from a transparent-type material and wherein said tooth pick further has a number of markings on a surface thereof which are positioned at predetermined locations so as to enable an indication to be provided to the user of the amount of removed particles.

12. The tooth pick according to claim 10, wherein at least a part of said tooth pick is coated with an anti-bacterial coating.

13. The tooth pick according to claim 10, wherein the one end is tapered at an angle with regard to a line perpendicular to a longitudinal axis of the tooth pick which has a value greater than 0 degrees and less than 90 degrees.

14. The tooth pick according to claim 10, wherein the opening extends from the one end to an opposite end.

15. A dental tooth pick assembly for enabling a user to remove an undesired particle or particles from or between one or more of the user's teeth, said assembly having a handle portion which enables the user to hold said tooth pick during use and a removable end portion having an outer cross-sectional shape which has a dimension having a value of approximately 4 mm or larger, said end portion having an opening for enabling the removed undesired particle or particles to be collected therein.

16. The tooth pick assembly of claim 15, wherein at least a part of said end portion is fabricated from a transparent-type material which includes a number of markings on a surface thereof which are positioned at predetermined locations so as to enable an indication to be provided to the user of the amount of removed particles.

17. The tooth pick assembly of claim 15, wherein at least a part of said end portion is coated with an anti-bacterial coating.
